(19) United States
(12) Patent Application Publication
(10) Pub. No.: US 2025/0356272 A1
(43) Pub. Date: Nov. 20, 2025

(54) DRYING EQUIPMENT USAGE AUDIT SYSTEM AND METHOD

(71) Applicant: NOVADATA SOLUTIONS LLC, Haverford, PA (US)

(72) Inventors: Anthony Troy, Haverford, PA (US); Emily Stucky, Haverford, PA (US); Ansley Scurlock, Haverford, PA (US); Chris Troy, Haverford, PA (US)

(21) Appl. No.: 19/196,969

(22) Filed: May 2, 2025

Related U.S. Application Data
(60) Provisional application No. 63/642,283, filed on May 3, 2024.

(51) Int. Cl. G06Q 10/063; G06Q 10/20

(52) U.S. Cl. CPC G06Q 10/063; G06Q 10/20

(57) ABSTRACT

A computer-implemented method for auditing drying equipment usage is described. The computer-implemented method includes the steps of receiving a set of drying equipment data about drying equipment units. Each of the drying equipment units are associated with a drying capacity data parameter. The method steps include receiving a set of spatial data associated with an area that the drying equipment units are located, and generating a first audit result data comprising a drying time duration parameter.

### CROSS-REFERENCE TO RELATED APPLICATIONS

This application claims priority to U.S. provisional application No. 63/642,283, filed on May 3, 2024 incorporated herein by reference in its entirety.

### BACKGROUND OF THE INVENTION

When remediation companies respond to water damage, their main goal is to dry out the affected structure as quickly and efficiently as possible to prevent mold growth and further deterioration. They often start by extracting any standing water using heavy-duty pumps or vacuums. Once the bulk of the water is removed, they strategically place air movers-high-velocity fans-throughout the area to promote rapid airflow across wet surfaces like floors, walls, and furniture. This airflow helps lift moisture from materials into the air. To capture this moisture, they may also set up commercial-grade dehumidifiers, which pull water vapor out of the air and lower the overall humidity, accelerating the drying process. Technicians closely monitor the moisture levels in both the air and materials using specialized tools like moisture meters and hygrometers, adjusting the equipment as needed to target stubborn wet spots. In cases where moisture is trapped behind walls or under floors, they might use specialized systems like inject-dry setups to force dry air into hidden spaces. Throughout the process, careful planning and regular monitoring ensure that drying is thorough and efficient, minimizing the risk of secondary damage.

In the demanding realm of facility risk management and property loss expense control, ensuring the effectiveness and efficiency of cost containment strategies is crucial. A significant concern frequently voiced is the lack of trust in invoices from emergency mitigation service companies. Specifically, there is frustration regarding the validity of equipment charges. Questions about charges often include: Are there too many pieces of equipment? Were the pieces of equipment utilized for the correct length of time? Were the rates fair and consistent with the industry? Did the emergency mitigation company adhere to industry standards? How can I answer all these questions to ensure that my invoice is accurate? These are challenges faced by facility managers, maintenance professionals, risk managers, adjusters and property insurance claim managers.

Historically, assessing equipment usage has been laborious, susceptible to human mistakes, and frequently neglected. Even when these types of reviews were conducted, it was typically a manual process, prone to discrepancies, inaccuracies, inefficiencies and includes ever escalating expenses associated with comprehensive review. Determining the proper use (number of units, duration of usage) of drying equipment for emergency remediation is critical. There is a lack of clear, concise, standards based estimation for this equipment. Using too much is a cost burden for the insured, using too little could allow mold and force more costly remediation steps. A system and method for determining the right amount of equipment, for that exact job, with the spaces and rooms in it, would represent an impactful improvement in the industry.

Thus, there is a need in the art for a system and method for auditing drying equipment usage the addresses the needs described above.

### SUMMARY OF THE INVENTION

In one embodiment, a computer-implemented method for auditing drying equipment usage includes the steps of receiving a set of drying equipment data about a plurality of drying equipment units, wherein each of the plurality of drying equipment units is associated with a drying capacity data parameter; receiving a set of spatial data associated with an area that the plurality of drying equipment units are located; and generating a first audit result data comprising a drying time duration parameter. In one embodiment, the method includes receiving a set of drying time data; and generating a second audit result data based on comparing thy drying time data to the first audit result data. In one embodiment, the method includes generating a third audit result data based on comparing the second audit result data to a drying equipment rate table.

A system for auditing drying equipment usage includes a computer comprising a storage device having a database management system, and computer-readable program code including steps for receiving a set of drying equipment data about a plurality of drying equipment units, wherein each of the plurality of drying equipment is units associated with a drying capacity data parameter, receiving a set of spatial data associated with an area that the plurality of drying equipment units are located, and generating a first audit result data comprising a drying time duration parameter. In one embodiment, the computer-readable program code further includes steps for: receiving a set of drying time data, and generating a second audit result data based on comparing thy drying time data to the first audit result data. In one embodiment, the computer-readable program code further includes generating a third audit result data based on comparing the second audit result data to a drying equipment rate table.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1A is a diagrams of a computing system and environment according to one embodiment, FIG. 1B is a flow chart of a computer-implemented method for auditing drying equipment usage, and FIGS. 1C and 1D are diagrams of AI-enhanced equipment budget engines for implementing the method for auditing drying equipment usage according to one embodiment.

FIGS. 2A-2C show example equipment assessment scenarios of recommended number of machines & number of days according to one embodiment.

FIGS. 3A-3D show an example of a property site assessment according to one embodiment.

FIGS. 4A and 4B show an example of a property site assessment according to one embodiment.

FIGS. 5A-5D show an example of a property site assessment according to one embodiment.

### DETAILED DESCRIPTION OF THE INVENTION

It is to be understood that the figures and descriptions of the present invention have been simplified to illustrate elements that are relevant for a more clear comprehension of the present invention, while eliminating, for the purpose of clarity, many other elements found in systems and methods of auditing drying equipment usage. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Referring now in detail to the drawings, in which like reference numerals indicate like parts or elements throughout the several views, in various embodiments, presented herein is an auditing drying equipment usage system and method.

A system and method to determine the impact for using reasonable equipment expenditures for emergency moisture removal from chambers (rooms) is described. The system and method take into account parameters (quantity, duration) used, real data stored from real jobs (RA), standards-based calculations and tables, “equipment budget” to set a standards-based baseline, actual volumetric calculations based on real dimensions, and equipment identification and ranking. All those parameters can be used as inputs and outputs with reality engines. The reality engines create a reasonable budget for equipment, reasonable drying times and estimations, and the reasonable financial impact. Not all financial impacts are just lowering cost (ensuring not too much equipment is used). Using too few equipment units can end up costing more to remediate as moisture is not removed quickly enough. Embodiments of the invention have several advantages, including an automated data-driven approach, leveraging cutting-edge technology and processes, eliminating manual errors, reduction in audit time, and providing real-time insights into equipment utilization.

In one embodiment, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In one embodiment, elements of the networked portion of the invention may be implemented over a Virtual Private Network (VPN).

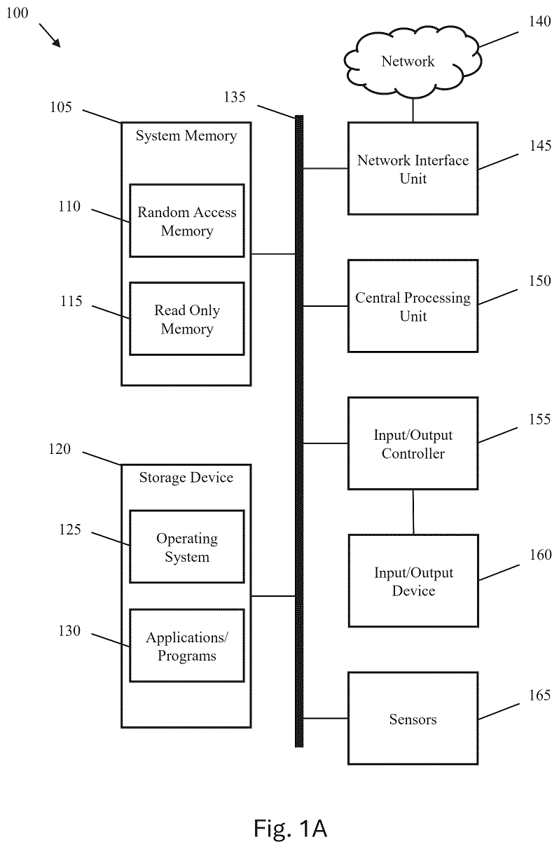

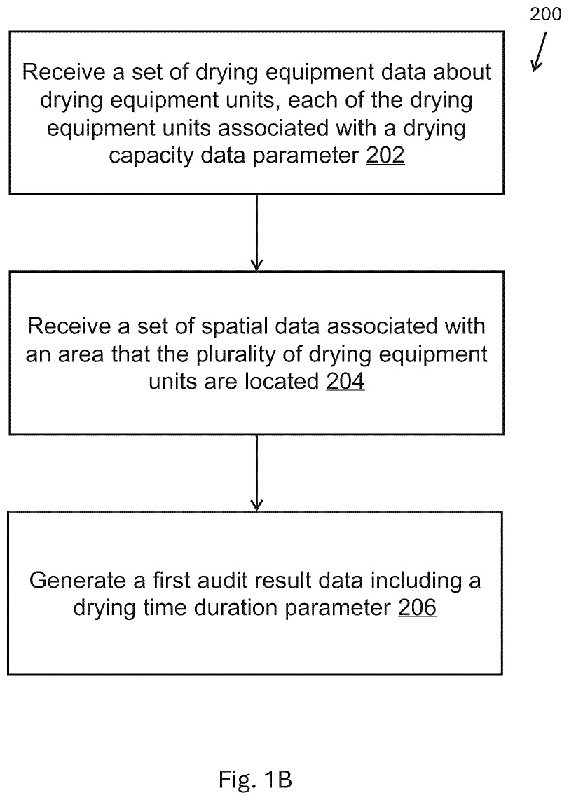

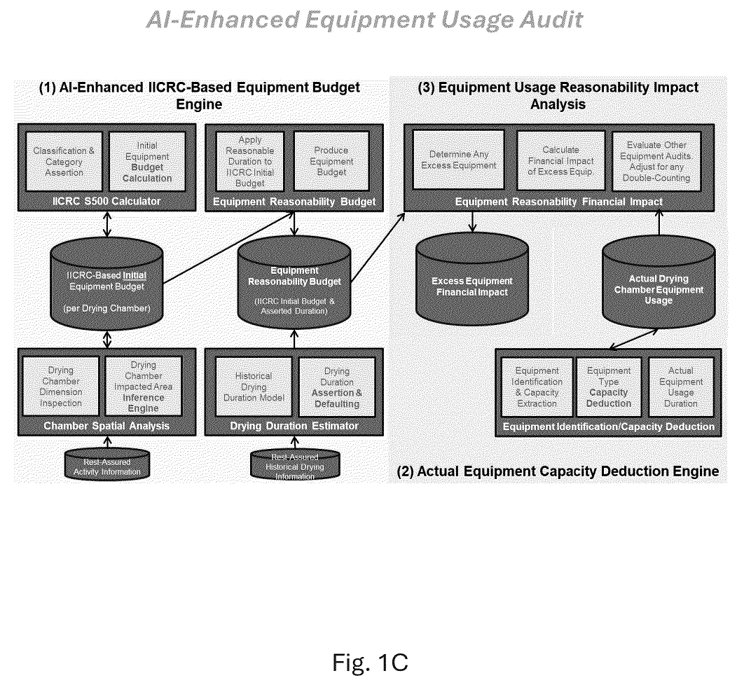

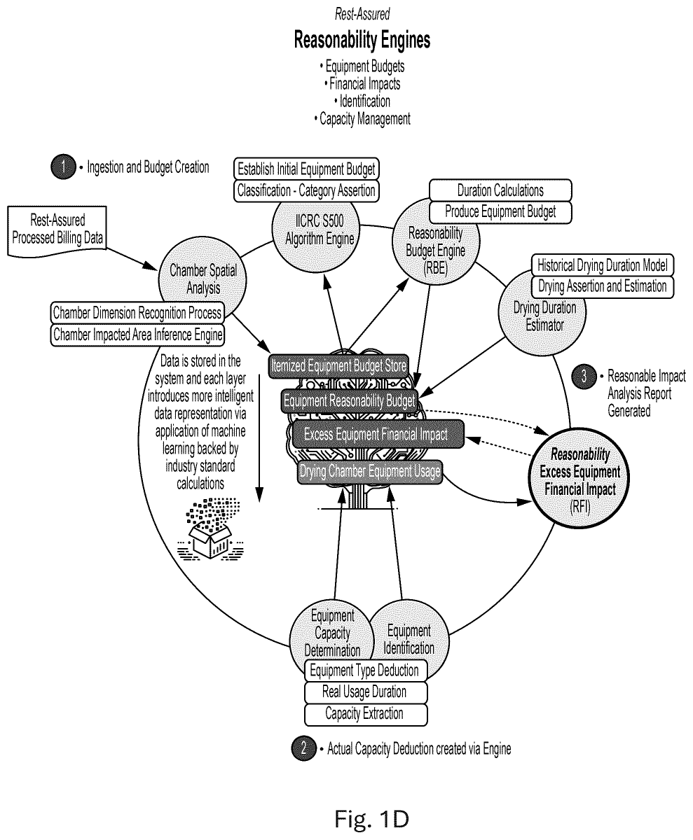

FIGS. 1A-1D and the following discussion provide a description of a suitable computing environment in which the invention may be implemented according to one embodiment. While embodiments of the invention are described in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

The computer architecture shown in FIG. 1A illustrates according to one embodiment a conventional personal computer, including a central processing unit 150 (“CPU”), a system memory 105, including a random access memory 110 (“RAM”) and a read-only memory (“ROM”) 115, and a system bus 135 that couples the system memory 105 to the CPU 150. A basic input/output system containing the basic routines that help to transfer information between elements within the computer, such as during startup, is stored in the ROM 115. The computer 100 further includes a storage device 120 for storing an operating system 125, application/program 130, and data.

The storage device 120 is connected to the CPU 150 through a storage controller (not shown) connected to the bus 135. The storage device 120 and its associated computer-readable media provide non-volatile storage for the computer 100. Although the description of computer-readable media contained herein refers to a storage device, such as a hard disk or CD-ROM drive, it should be appreciated by those skilled in the art that computer-readable media can be any available media that can be accessed by the computer 100.

One or more computers are implemented into embodiments of the system as shown for example in FIGS. 1C and 1D for providing functionality of the various modules and implementing the method 200 of FIG. 1B. By way of example, and not to be limiting, computer-readable media of the drying equipment audit platform may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 100 and drying equipment audit platform may operate in a networked environment using logical connections to remote computers through a network 140, such as TCP/IP network such as the Internet or an intranet. The computer 100 may connect to the network 140 through a network interface unit 145 connected to the bus 135. It should be appreciated that the network interface unit 145 may also be utilized to connect to other types of networks and remote computer systems.

The computer 100 and drying equipment audit platform may also include an input/output controller 155 for receiving and processing input from a number of input/output devices 160, including a keyboard, a mouse, a touchscreen, a camera, a microphone, a controller, a joystick, or other type of input device. Similarly, the input/output controller 155 may provide output to a display screen, a printer, a speaker, or other type of output device. The computer 100 can connect to the input/output device 160 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above and shown for example in FIGS. 1A-1C, a number of program modules and data files may be stored in the storage device 120 and/or RAM 110 of the computer 100, including an operating system 125 suitable for controlling the operation of a networked computer. The storage device 120 and RAM 110 may also store one or more applications/programs 130. In particular, the storage device 120 and RAM 110 may store an application/program 130 for providing a variety of functionalities to a user. For instance, the application/program 130 may comprise many types of programs such as a word processing application, a spreadsheet application, a desktop publishing application, a database application, a gaming application, internet browsing application, electronic mail application, messaging application, and the like. According to an embodiment of the present invention, the application/program 130 comprises a multiple functionality software application for providing word processing functionality, slide presentation functionality, spreadsheet functionality, database functionality and the like.

The computer 100 in one embodiment can include a variety of sensors 165 for monitoring the environment surrounding and the environment internal to the computer 100. These sensors 165 can include sensors specific to monitoring drying and humidity equipment and effectiveness, such as monitoring fluctuations in environment humidity or moisture levels, or sensors monitoring equipment performance. Other sensors may be integrated into the system, such as a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

With reference now to FIGS. 1B-1D, generally, embodiments of the invention may include a computer-implemented method 200 for auditing drying equipment usage. The computer-implemented method 200 includes the steps of receiving a set of drying equipment data about various drying equipment units, where each of the drying equipment units is associated with a drying capacity data parameter 202. A set of spatial data is received, the spatial data associated with an area that the drying equipment units are located 204. Finally, a first audit result data is generated, the data including a drying time duration parameter 206. In one embodiment, the method 200 may include the steps of receiving a set of drying time data, and generating a second audit result data based on comparing thy drying time data to the first audit result data. In one embodiment, the method 200 may include the step of generating a third audit result data based on comparing the second audit result data to a drying equipment rate table.

An AI-enhanced equipment budget engine for implementing the method 200 is now described more specifically according to one embodiment with specific reference to FIGS. 1C and 1D.

Chamber Spatial Analysis (CSA). A spatial analysis is required to feed the IICRC Equipment Calculation Engine the requisite data to produce an estimate of the “initial” amount of equipment, by type, to dry each chamber. Key data needs include dimensions of the full chamber and the impact area within the chamber.

Drying Chamber Dimension Inspection. CSA consumes physical dimensions of each drying chamber as listed on the estimate to establish a foundational dataset to evaluate the necessary equipment to dry the chamber. The data is extracted from the estimate through various OCR tools and techniques.

Drying Chamber Impacted Area Inference Engine. CSA also needs to determine the impacted areas of the chamber. CSA performs an inspection of activities listed in each chamber as noted on the estimate. Rest-Assured has an inference engine that will look for specific types of activities and the amount of area the activity addressed. Often, there is not enough information associated directly with the activity to determine the area that was affected. In these cases, the inference engine needs to leverage other dimensions listed at the chamber level.

IICRC S500 Equipment Calculator (ISEC). The IICRC Calculator leverages formulas defined in the IICRC S500 Water Remediation Standards document. Before executing the formulas, the calculator needs to determine the Class and Category of the event. Once the class and category are determined, the calculator needs the full dimensions of the room and the impacted areas to determine a budget of equipment.

Classification & Category Assertion. The equipment formulas defined in the IICRC Standards require that a classification and categorization of the loss be determined. This information is often not included or is incomplete. This requires the C&C Assertion Engine to inspect key pieces of information, leverage industry norms and prior data to assert a classification and categorization. If classification and categories cannot be determined by other data, a default parameter value is used.

Initial Equipment Budget Calculation. The ISEC leverages the dimensions of each chamber and the impacted areas in each chamber (as calculated in CSA), along with the classification and category to execute a series of IICRC S500 calculations to produce an estimate of air movers, dehumidifiers and air scrubbers (and any future equipment the IICRC defines) that is appropriate for the job. The IICRC standards do not calculate a duration, so this is just an “initial” amount of equipment to start the job.

Drying Duration Estimator. IICRC does not provide specific guidance on how much time it should take to dry a chamber, though it does provide techniques to ensure technicians know how to dry chambers as quickly as possible regardless of varying weather conditions inside or outside the building (extra humid or extra dry) or structural materials (drywall, carpet, hardwood etc.). So, to determine a fair reasonability check on the number of pieces of equipment to dry a chamber, a baseline drying duration needs to be determined.

Historical Drying Duration Model. The system contains a rich dataset of restoration estimates that contain drying equipment, chambers and drying times. Since the drying times are fully in control of the restoration companies, an underlying assumption is that the dataset may skew towards longer drying times as there is a revenue motivation to keep equipment on-site longer than necessary. The model considers that and applies an index to normalize a standard drying duration.

Drying Duration Assertion & Defaulting (future). Based on certain attributes of the job (industry, building materials, geography etc.), the Drying Assertion Engine considers various metrics in the Duration Model then selects an appropriate default to apply towards an individual assessment.

### Equipment Usage Reasonability Budget (EURB)

Apply Default Duration to IICRC Initial Equipment Budget. The EURB service has the responsibility of taking the IICRC-based Initial Equipment Usage Budget and the Drying Duration Default to generate an Equipment Reasonability Budget for each chamber per each type of equipment.

### Equipment Identification/Capacity Deduction (EICD)

To produce a reasonability assessment using a budget requires that the capacity of the equipment used on the job is available.

Equipment Identification & Capacity Extraction. Embodiments of the system have a robust pdf scraping platform that extracts pertinent data from estimates (and invoices). Often the equipment used on the job is clearly noted with its name, model and capacity in its name. In these cases, the EICD will inspect and extract the capacity (ex: number of pints per day a dehumidifier can extra from the air) to pass on to the IICRC Budget Calculator and the Actual Drying Chamber Usage Service. In some cases, the equipment on the estimate is not clearly named and does not present a model or capacity. In those cases, the service leveraged best practice and industry normal to assert a size and capacity. If an adjuster or restoration company contests the default, they can provide the actual name, size and capacity of the machine and the reasonability audit can be re-executed.

Equipment Type Capacity Deduction (future). Rest-Assured has a peer-to-peer equipment model that has a robust set of equipment along with their capacity. If a capacity is not explicitly stated on the estimate, and the EICD services finds a match in the peer-to-peer equipment model, the capacity can be used from that source. This helps with the confidence in the capacity inclusions in the calculations.

Actual Equipment Duration. Rest-Assured has a robust pdf scraping platform that extracts pertinent data from estimates (and invoices) including the number of days pieces of equipment are in use. Often this information is buried in paragraphs of text. Natural Language Processing techniques are used to identify the numbers of pieces of equipment used in terms of days. This is critical to compare to the budget calculated in the Equipment Usage Reasonability Budget (EURB) service.

Equipment Reasonability Financial Impact (ERFI). The Equipment Reasonability Financial Impact service is the final step in producing an assessment of the number of pieces of equipment used in the estimate and ultimately the financial impact that will be proposed to be deducted from the restoration company's estimate.

Determine Excess Equipment Total. This service will obtain the Equipment Reasonability Budget (produced out of the AI-Enhanced IICRC-Based Equipment Budget Engine) and the Actual Number of Equipment Used to dry the chambers (produced out of the Actual Equipment Capacity Deduction Engine) and will produce an assessment on if too many pieces of equipment were used (by type) and if the magnitude.

Calculate Financial Impact of Excess Equipment. This service take the amount of excess equipment by type and applies it against the rate charged for each piece of equipment and generates a financial impact by equipment type and a total for the estimate.

Evaluate Other Equipment Audits. And Adjust for any Double-Counting. Rest-Assured has many audits that evaluate equipment beyond the usage reasonability. These audits include equipment rates and equipment term discount. It is possible that multiple audits identified issues, so this service will inspect other equipment audits and generate an appropriate adjustment to ensure there is no double counting.

### Experimental Examples

The invention is now described with reference to the following Examples. These Examples are provided for the purpose of illustration only and the invention should in no way be construed as being limited to these Examples, but rather should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore, specifically point out the preferred embodiments of the present invention, and are not to be construed as limiting in any way the remainder of the disclosure.

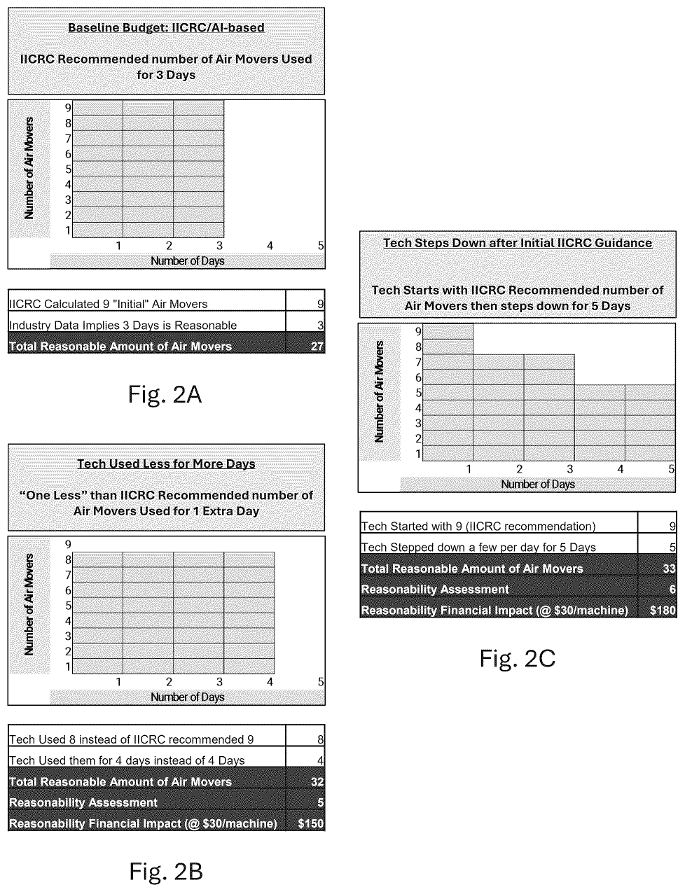

FIGS. 2A-2C show example equipment assessment scenarios of recommended number of machines and number of days.

Embodiments of the equipment usage reasonability audit leverage a combination of sophisticated techniques that elegantly combines IICRC standards, spatial analysis, and equipment capacity assessment, while leveraging rich datasets and a parameterized platform to provide comprehensive insights into equipment utilization and costs. Each component contributes to the effectiveness of our solution:

Standards: Standards may for example follow the Institute of Inspection, Cleaning and Restoration Certification (IICRC) standards for the inspection, cleaning, and restoration industries. By aligning the audit process with standards guidance, vendors are complying with defined requirements, standards of care, and adhere to best practices in equipment usage. Standards may include for example:

### Air Mover Calculations—

1 air mover “in each affected room”
1 air mover “for every 50-70 SF” of affected wet floor in each room . . . ”
1 air mover “for every 100-150 SF of affected wet ceiling and wall areas above approximately 2 feet . . . ”
1 air mover “for each wall inset and offset greater than 18 inches”

### Dehumidifier Calculations—

“calculate an approximate minimum dehumidification capacity for initial humidity control . . . . Divide the factor into the cubic footage of the environment. This yields an approximate minimum number of AHAM (Association of Home Appliance Manufacturers) pints of dehumidification capacity for initial humidity control”

Spatial Analysis: Understanding the spatial dynamics of the structure is crucial for calculating the optimal number of machines to dry the space. By automatically extracting and analyzing the dimensions of each room provided on estimates, reviewers make informed decisions that consider the specific structure and its rooms when balancing drying time with the cost of equipment.

Equipment Capacity Assessment: Inefficient deployment of equipment can lead to significant increases in the cost of remediation and unnecessary delays in returning the business to its pre-loss condition thus increasing business interruption losses. Having too few pieces of equipment could result in extra days being required to dry the structure, which can increase costs and lead to secondary damages. Having too many pieces of equipment may not help the structure dry quicker, and just results in higher costs. By analyzing the total number of drying equipment used, the capacity of each, and the amount of time each piece of equipment was in use, a budget of equipment by type is compared to the actual number of pieces of equipment that the restoration company used. This information is critical to eventually determine if there were too many of a certain type of equipment and the financial impact.

Rich Datasets: The system leverages a rich dataset of peer-to-peer information related to prior drying jobs executed by a variety of restoration companies. Leveraging real data to support foundational assumptions is key to our goal of being fair and unbiased in our assessments.

Parameterized Platform: Audits begin with the understanding that no two jobs are alike and that circumstances on the ground may require adjustments to an assumption. Parameters empower the community to override the assumptions and personalize the assessment to make it as appropriate and accurate as possible.

The result is a fair, unbiased, and data-driven “reasonability” assessment that is defensible during a negotiation. Whoever is negotiating with the restoration company can clearly see if the number of various types of equipment were reasonable and appropriate to dry the structure. This tool is extremely useful in avoiding unnecessary equipment expenditures.

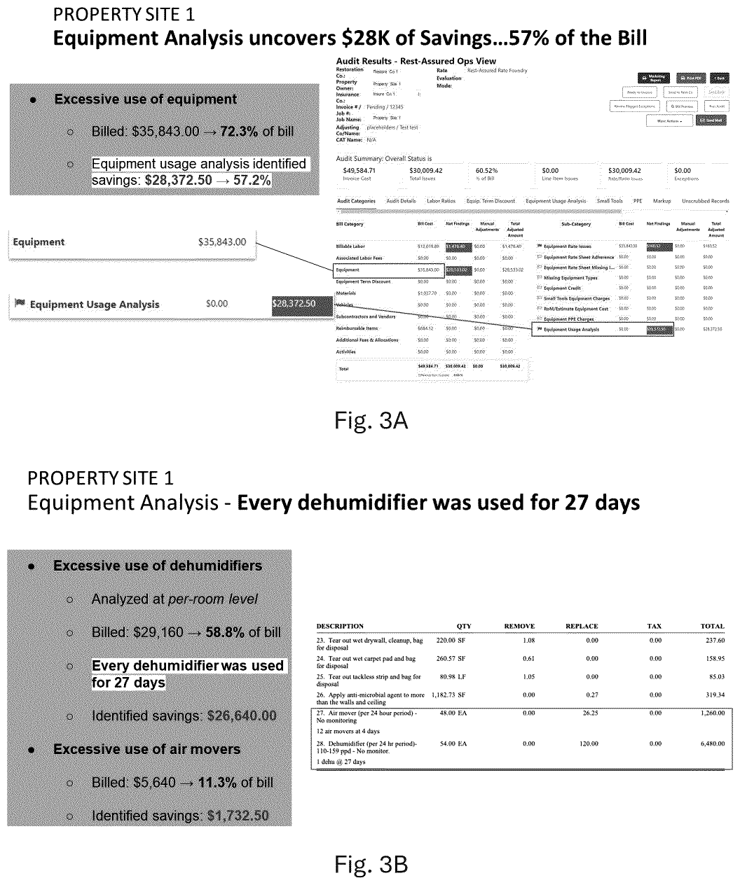

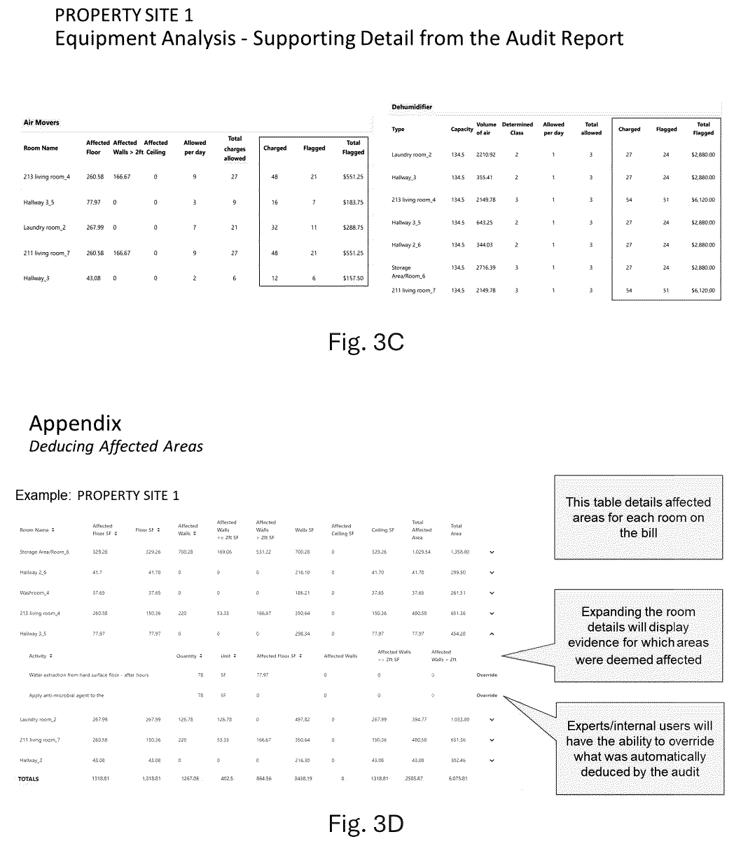

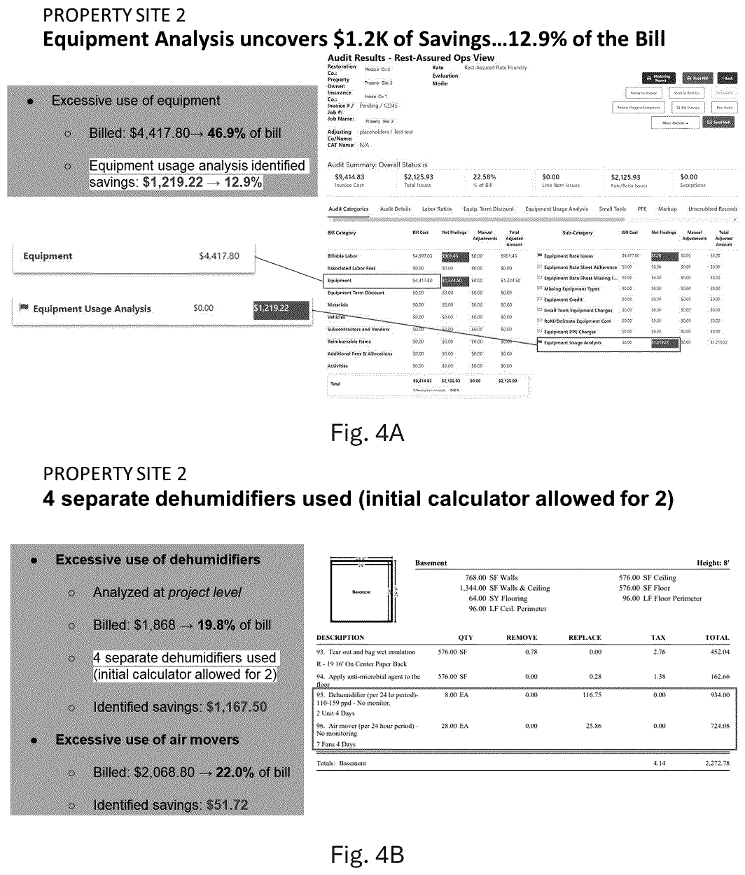

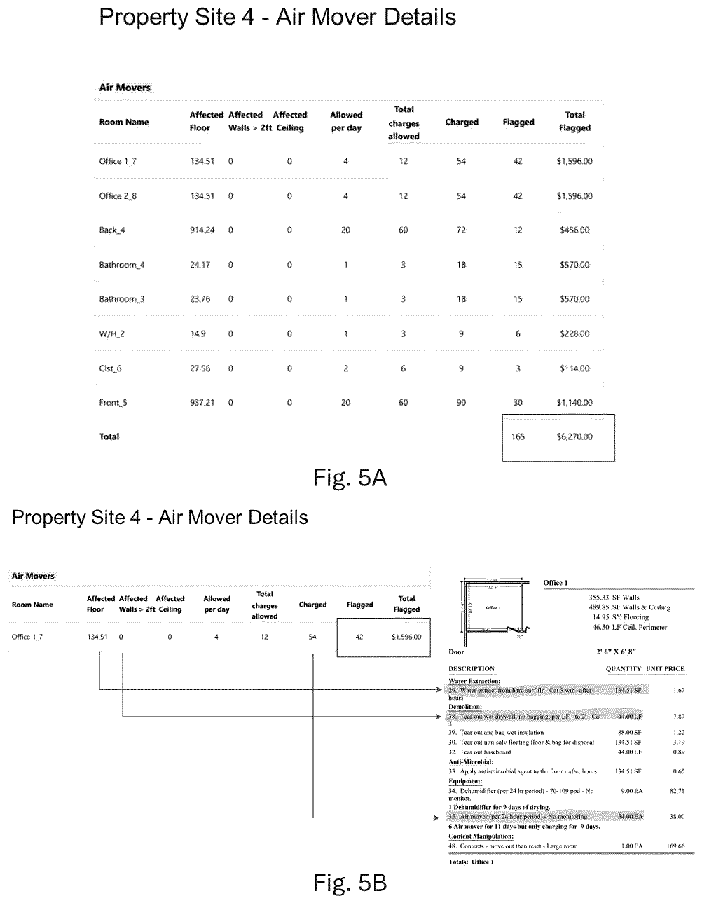

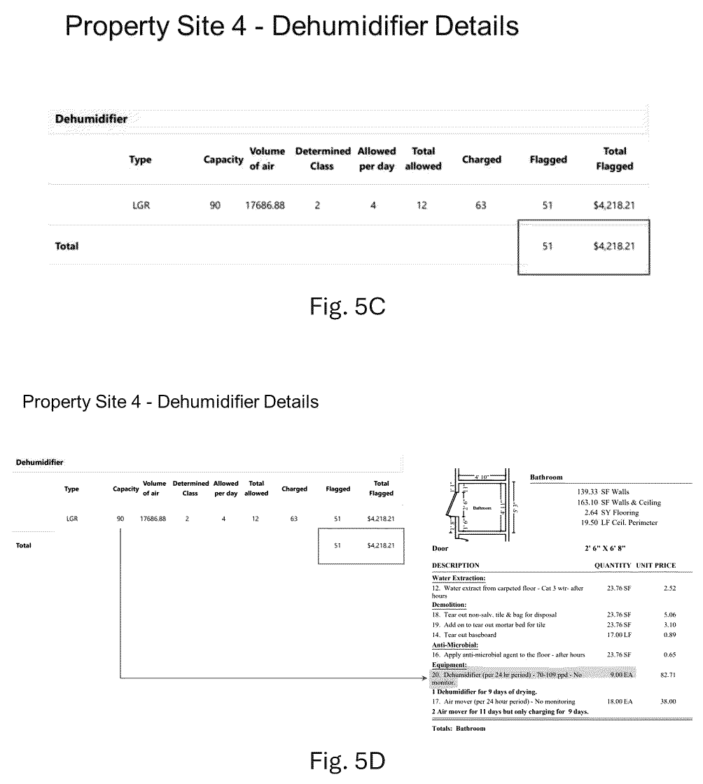

In the example of Property Site 1 shown in FIGS. 3A-3D, over $28,372,50 of savings (57.2% of the bill) were identified by findings of excessive use of equipment. Specifically, excessive use of dehumidifiers and excessive use of air movers contributed to overbilling. Another example is shown in FIGS. 4A and 4B where $1,219.22 of savings (12.9% of the bill) were identified by findings of excessive use of equipment. As shown for example in FIGS. 5A-5D, using for example standards for air move calculations and dehumidifier calculations discussed above, working examples for calculating excess air mover and dehumidifier usage are shown.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention.

What is claimed is:

1. A computer-implemented method for auditing drying equipment usage, the computer-implemented method comprising:
receiving a set of drying equipment data about a plurality of drying equipment units, wherein each of the plurality of drying equipment units is associated with a drying capacity data parameter;
receiving a set of spatial data associated with an area that the plurality of drying equipment units are located; and
generating a first audit result data comprising a drying time duration parameter.

2. The computer-implemented method of claim 1 further comprising:
receiving a set of drying time data; and
generating a second audit result data based on comparing the drying time data to the first audit result data.

3. The computer-implemented method of claim 2 further comprising:
generating a third audit result data based on comparing the second audit result data to a drying equipment rate table.

4. A system for auditing drying equipment usage comprising:
a computer comprising a storage device comprising:
a database management system, and
computer-readable program code including steps for:
receiving a set of drying equipment data about a plurality of drying equipment units, wherein each of the plurality of drying equipment is units associated with a drying capacity data parameter,
receiving a set of spatial data associated with an area that the plurality of drying equipment units are located, and
generating a first audit result data comprising a drying time duration parameter.

5. The system of claim 4, wherein the computer-readable program code further includes steps for:
receiving a set of drying time data, and
generating a second audit result data based on comparing the drying time data to the first audit result data.

6. The system of claim 5, wherein the computer-readable program code further includes steps for:
generating a third audit result data based on comparing the second audit result data to a drying equipment rate table.
